(19) United States
(12) Patent Application Publication
(10) Pub. No.: US 2007/0070227 A1
(43) Pub. Date: Mar. 29, 2007

(54) Complementary color detection device

(75) Inventors: Den-Hua Lee, Hsinchu City (TW); Kuan-Rong Lee, Hsinchu City (TW); Wen-Long Yao, Taichung County (TW); Ming-Huei Chen, Taoyuan County (TW); Sheng-Ying Cheng, Taipei City (TW); Chia-Chan Li, Kaohsiung City (TW)

Correspondence Address: BIRCH STEWART KOLASCH & BIRCH, PO BOX 747, FALLS CHURCH, VA, 22040-0747, US

(73) Assignee: Beam Gene Corporation Ltd.

(21) Appl. No.: 11/371,003

(22) Filed: Mar. 9, 2006

(30) Foreign Application Priority Data
Sep. 29, 2005 (TW) 94133957

(51) Int. Cl. H04N 9/04

(52) U.S. Cl. 348/280

(57) ABSTRACT

The invention provides a complementary color detection device receiving a light source and outputting a complementary color reading thereof, comprising a filter extracting a red, green and blue light component from the light source; and a detector receiving the red green and blue light components and outputting a first, second and third reading respectively, wherein the complementary color reading is a combination of the first, second and third readings, and each of the first, second and third readings is a voltage difference between a first and second terminal of a light detection device.

### BACKGROUND

The invention is related to color detection and, more particularly, to a complementary color detection device receiving a light source and outputting a complementary color reading thereof.

FIG. 1 is a block diagram of a conventional color detection device 10, comprising a filter 11, a detector 12 and a converter 13. Red, green and blue light components L_{R}, L_{G} and L_{B} are extracted from light source L_{T} by filter 11. Detector 12 receives Red, green and blue light components L_{R}, L_{G} and L_{B} and outputs Red, green and blue illumination reading voltages V_{R}, V_{G} and V_{B}, combined as a color reading of the light source L_{T}. Phototransistors 121, 123 and 125 receives red, green and blue light components L_{R}, L_{G} and L_{B} respectively. Because the induced current of a phototransistors is proportional to the received light illumination, when the luminance of the Red, green and blue light components L_{R}, L_{G} and L_{B} increases, the current through resistors 122, 124 and 126 increases, and the voltage values of V_{R}, V_{G} and V_{B} increase correspondingly. The phototransistors 121, 123 and 125 can be replaced by photodiodes (not shown) with similar characteristics.

Conventionally, when complementary color readings of the light source L_{T} are required, converter 13 is needed to convert the color reading combined by V_{R}, V_{G} and V_{B} to a complementary color reading combined by V_{RC}, V_{GC} and V_{BC}.

For a system requiring only complementary color readings, direct detection of complementary color readings is needed for a more compact design.

### SUMMARY

The invention provides a complementary color detection device receiving a light source and outputting a complementary color reading thereof, comprising a filter extracting red, green and blue light components from the light source; and a detector receiving the red green and blue light components and outputting a first, second and third reading respectively, wherein the complementary color reading is a combination of the first, second and third readings, and each of the first, second and third readings is a voltage difference between a first and second terminal of a light detection device.

### DESCRIPTION OF THE DRAWINGS

The accompanying drawings, incorporated in and constituting a part of this specification, illustrate embodiments of the invention and, together with the description, serve to explain the features, advantages, and principles of the invention.

FIG. 1 is a block diagram of a conventional color detection device.

FIG. 2 is a block diagram of a complementary color detection device according to the invention.

### DETAILED DESCRIPTION

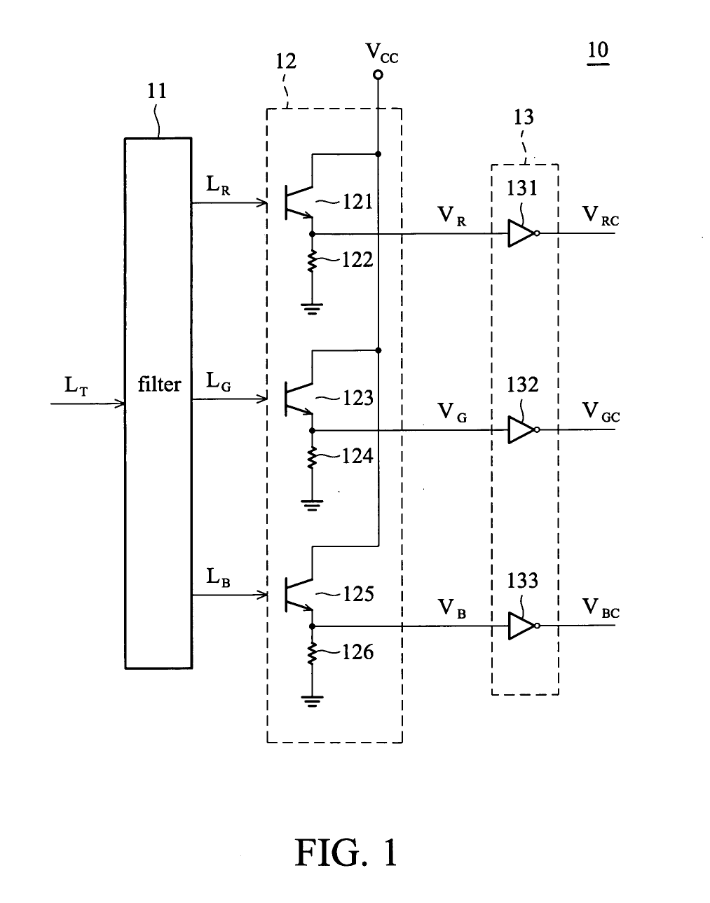

Because the sum of a color and complementary color reading of a light source equals a color reading of a full gradient white light source, defined as a reading where V_{R}, V_{G} and V_{B} all equal a operating voltage V_{CC} of the color detection device 10 of FIG. 1, the complementary color can be acquired by combining the values of respectively subtracting V_{R}, V_{G} and V_{B} from operating voltage V_{CC}, and equivalent to the combination of voltage values V_{RC}, V_{GC} and V_{BC}, converted by inverter 131, 132 and 133 from V_{R}, V_{G} and V_{B}, respectively.

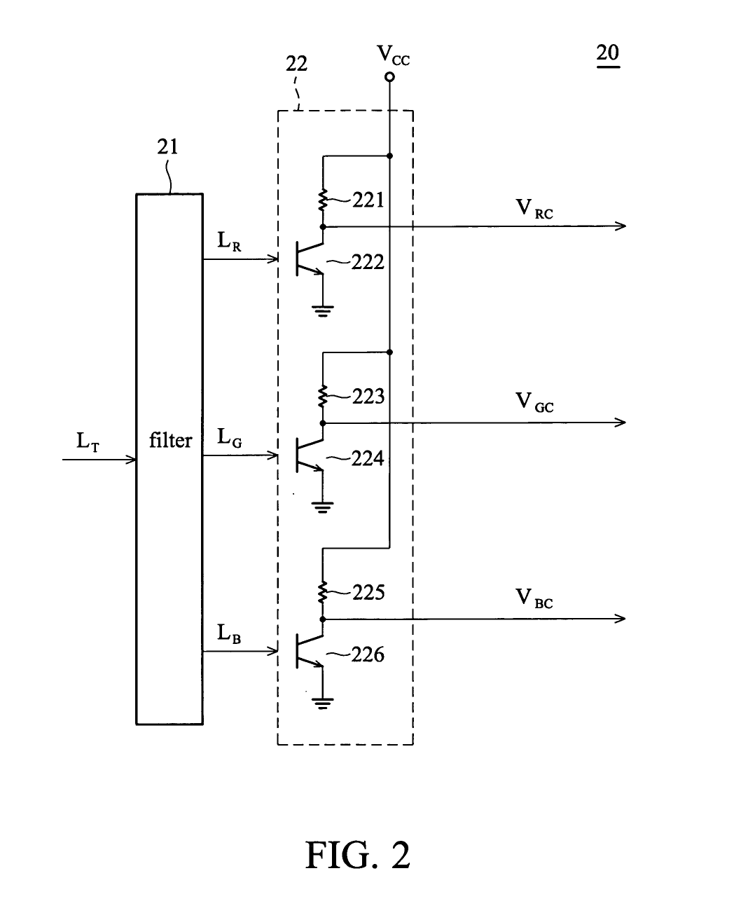

FIG. 2 is a block diagram of a complementary color detection device 20 according to the invention. Complementary color detection device 20 comprises a filter 21 and a detector 22. Red, green and blue light components L_{R}, L_{G} and L_{B} are extracted from light source L_{T} by filter 21. Detector 22 receives red, green and blue light components L_{R}, L_{G} and L_{B} and outputs Red, green and blue reading voltages V_{RC}, V_{GC} and V_{BC}, combined as a complementary color reading of the light source L_{T}. Phototransistors 222, 224 and 226 receive Red, green and blue light components L_{R}, L_{G} and L_{B} respectively. Because the induced current of a phototransistor is proportional to the received light illumination, when the luminance of the red, green and blue light components L_{R}, L_{G} and L_{B} increases, the current through resistors 221, 223 and 225 increases, and the voltage differences between 2 terminals of resistors 221, 223 and 225 increase correspondingly. Thus, the voltage differences between 2 terminals of resistors 221, 223 and 225 are equivalent to the luminance reading of L_{R}, L_{G} and L_{B}. Since the voltage differences between 2 terminals of phototransistors 222, 224 and 226, i.e. V_{RC}, V_{GC} and V_{BC}, respectively subtract voltage differences between 2 terminals of resistor 221, 223 and 225 from operating voltage V_{CC}, the combination of V_{RC}, V_{GC} and V_{BC} is equivalent to the complementary color reading of the light source L_{T}. The phototransistors 222, 224 and 226 can be replaced by photodiodes (not shown) with similar characteristics.

Please note that in this embodiment, if the chosen light detection devices (phototransistor or photodiode) and resistors of the detector have compatible footprints, the output reading can be modified from complementary color reading to color reading, by simply swapping the location of the light detection devices and the resistors. For example, by assembling resistors 221, 223 and 225 at the original location of phototransistors 222, 224 and 226, and phototransistors 222, 224 and 226 at the original location of resistors 221, 223 and 225, the combination of output voltage values V_{RC}, V_{GC} and V_{BC} can be modified to a color reading.

The invention provides a compact design for systems requiring only complementary color readings. The invention also provides a flexible design utilizing a single printed circuit board layout for both complementary color reading and color reading systems.

While the invention has been described by way of example and in terms of preferred embodiment, it is to be understood that the invention is not limited thereto. Those skilled in the technology can still make various alterations and modifications without departing from the scope and spirit of this invention. Therefore, the scope of the present invention shall be defined and protected by the following claims and their equivalents.

What is claimed is:

1. A complementary color detection device receiving a light source and outputting a complementary color reading thereof, comprising:
a filter extracting red, green and blue light components from the light source; and
a detector receiving the red green and blue light components and outputting a first, second and third reading respectively, wherein the complementary color reading is a combination of the first, second and third readings, and each of the first, second and third readings is a voltage difference between a first and second terminal of a light detection device.

2. The complementary color detection device as claimed in claim 1, wherein the light detection device is a phototransistor.

3. The complementary color detection device as claimed in claim 1, wherein the light detection device is a photodiode.

4. The complementary color detection device as claimed in claim 1, wherein the light detection device receives the red light component and has the first terminal coupled to a ground voltage and the second terminal coupled to an operating voltage through a resistor, outputting the first reading.

5. The complementary color detection device as claimed in claim 1, wherein the light detection device receives the green light component and has the first terminal coupled to a ground voltage and the second terminal coupled to an operation voltage through a resistor, outputting the second reading.

6. The complementary color detection device as claimed in claim 1, wherein the light detection device receives the blue light component and has the first terminal coupled to a ground voltage and the second terminal coupled to an operation voltage through a resistor, outputting the third reading.
